(19) United States
(12) Patent Application Publication
(10) Pub. No.: US 2026/0340637 A1
(43) Pub. Date: Oct. 29, 2026

(54) Biometric based, credit, debit, monetary service.

(71) Applicant: Navtej Singh Dhillon, Supply, NC (US)

(72) Inventor: Navtej Singh Dhillon, Supply, NC (US)

(21) Appl. No.: 19/658,640

(22) Filed: Apr. 26, 2026

Related U.S. Application Data
(60) Provisional application No. 63/795,487, filed on Apr. 27, 2025.

(51) Int. Cl. G06Q 20/40; G06Q 20/24; G06Q 20/26; G06Q 40/02

(52) U.S. Cl. CPC G06Q 20/40145; G06Q 40/02; G06Q 20/24; G06Q 20/26

(57) ABSTRACT

Intend to invent and create biometric identification based credit, debit, monetary service which uses biometrics identification. The service uses biometric identification instead of a card as is used today and no physical card, or any other device is used for this credit, debit service. The service is best described as “biometric credit” and replaces “credit card”, “debit card” or any physical device, as is being used today for credit, debit.

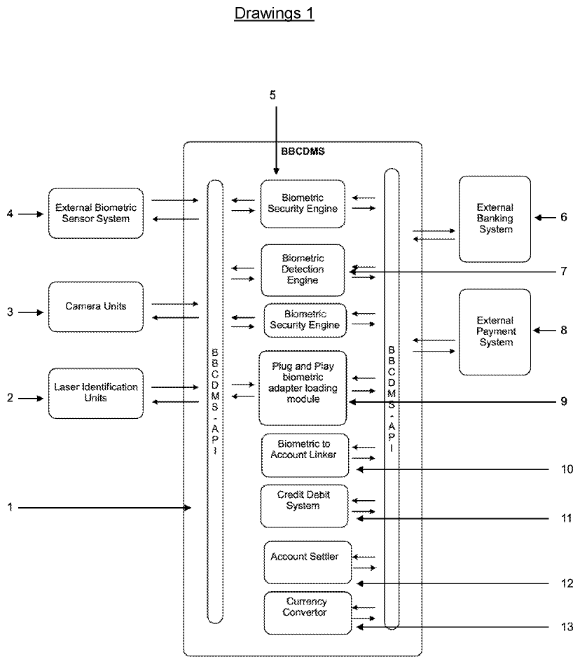

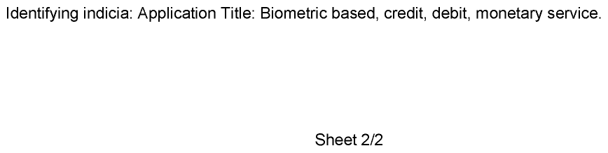

### CROSS-REFERENCE TO RELATED APPLICATIONS

Provisional Application: 63/795,487—: Biometric based, credit, debit, monetary service.

Filing or 371 (c) date

Filling Date: Apr. 27, 2025

### STATEMENT REGARDING FEDERALLY SPONSORED RESEARCH OR DEVELOPMENT (If APPLICABLE)

S.1 No, None

### BACKGROUND OF THE INVENTION

P1 The invention is creating, biometrics credit, debit service.

P2 Technical advances have not necessarily eased the use of technology.

P3 Technology has evolved but the interaction with technology still lags behind.

P4 More so no newer simpler ways of interaction with technology are prevalent.

P5 A physical credit card or device (e.g. phone) is still needed as a means of identification for payments, can some form of monetary or payment service be created which needs no physical card or physical device?

P6 Can effective use of biometrics be the solution for credit card, or debit card or other monetary needs?

### BRIEF SUMMARY OF THE INVENTION

B1 The invention is creating, biometrics credit, biometrics debit service and biometrics monetary gateway, which uses biometrics as such.

B2 Technical advances have not necessarily eased the use of technology, with the use biometric offering the intention is ease the use of the technology.

B3 Technology has evolved but the interaction with technology still lags behind, with this solution the interaction will be simplified by using the biometric data.

B4 More so no newer simpler ways of interaction with technology are prevalent, this invention intends to remove the hurdles of access to biometric data leading to simpler ways of interaction with the technology.

B5 E.g. checkout still takes same amount of time as before, multiple use cases can be supported by this offering which can act as an engine which can power newer use cases.

P5 A physical credit card or device (e.g. phone) is still needed as a means of identification for payments, with this invention biometrics can be used for the form of monetary or payment service which needs no physical card or physical device.

P6 The effective use of biometrics is the solution for credit card, or debit card or other monetary needs, as this inventions and the software, software as service as implemented does in this solution.

### BRIEF DESCRIPTION OF THE SEVERAL VIEWS OF THE DRAWING

DW.1 Drawing 1: Biometrics credit, biometrics debit service and biometrics monetary gateway.

DW.1.1 Drawing 1: Biometrics credit, biometric debit service and biometric monetary gateway. The system as such works as full fledged bank, with debit, credit services sorely based on biometrics. Further acts also as a full fledged monetary service based on biometrics, also biometric monetary payment gateway with other banking systems. Further as depicted in section D.1

DW.1.2 1 BBCDMS API, is the API layer which exposes all the sub systems and their functionality to both internal and external systems. Further as depicted in section D.1

DW.1.3 2 Laser Identification Unit, is the external laser system which is used for biometric identification. No claim is being made for the laser identification system as such, in the diagram the laser system depicts the feed from the laser system which is sent for the means of identification of biometrics identification. Further as described in section D.1.

DW.1.4 3 is Camera Unit, is cameras which capture the raw images for the means of biometric identification. The camera unit is the logical representation of a camera or set of cameras which send the feed to the system. Further as described in section D.1.

DW.1.5 4 is External Biometric Sensor System, is the external system which captures the biometrics and sends to the system as such. Further as described in section D.1

DW.1.6 5 is Biometric Security Engine, is the security engine which securely stores and transfers the biometric information. Further as described in section D.1

DW.1.7 6_is External Banking System, is the external banking system to which the system connects to for banking service based on biometrics. Here this BBCDMS system act both as a service which an external bank can use for only using the biometrics identification, or a full fledged banking system gateway which connects to another external banks. Here this BBCDMS system can act as a gateway or full fledged banking system based linking to the external bank. Further as described in section D.1.

DW.1.8 7_is Biometric detection detection engine, is the internal system which takes feeds from external biometric identification systems, cameras, laser units, and detects a given biometric feed to the identity of an entity, here the entity can be a person, or a finite set of physical assets that we use in our day to day life, like a car, bike. The set of objects is finite because the set of objects that we use in our day to day life are finite, and the only aspect is to the identification of the object. Further as described in section D.1.

DW.1.9 8_is External Payment System, is the external payment system to which the system connects to for payment service based on biometrics. Here this BBCDMS system act both as a service which an external bank can use for only using the biometrics identification, or a full fledged payment system gateway which uses its own payment system or connects to another payment gateways. Here this BBCDMS system can act as a gateway or full fledged banking system based linking to the external bank. Further as described in section D.1.

DW.1.10 9_is Plug and play biometric adapter loading module, this module which is re-sponsible for interfacing, linking and loading a particular external biometric system. Further as described in section D.1.

DW.1.11 10_ is Biometric to account linker, this module links a particular identification of an entity, a person, to the particular account for that entity, a person. The system here uses both, or or, a biometric imprint hash as an account or a alphanumeric has as a account number. Further as described in section D.1.

DW.1.12 11_is Credit Debit System, the system as such is core banking system which handles all the banking functions such as holding the monetary currency, keeping balances, creating bank accounts, issuing credit, debit accounts, just to name a few. As no claim is being made on the exclusiveness of this system, as the functions are typically the same that are being used by any bank for hundred of years, the only exception or exclusiveness is that the system as such only uses the biometrics as a means of identification, account verification and at times the account itself. Further as described in section D.1.

DW.1.13 12_is Account Settler, is the typical banking system module which settles the transections as they occur in normal banking system. As such no claim is being made for the module as such. The only exclusive claim is the system as such uses instant account settlement rather than traditional auth, pre auth as its exists in traditional banking system.

DW.1.14 13_is Currency Convertor, is the typical currency converter module that exists is normal banking systems. The system as such performs the functionality of converting one currency to another. As these modules already exists in normal banking systems, no exclusive claim is being made as such but the module is being shown for completeness.

### DESCRIPTION

### DETAILED DESCRIPTION OF THE INVENTION

D.1 The invention is creating, biometrics credit, biometrics debit service and biometrics monetary gateway, which uses biometrics as such. The service is similar to as today visa, master card is to using the “cards”, this new monetary service is the newer version of those, as it uses no cards or any device based identification but the biometrics.

D.2 Technical advances have not necessarily eased the use of technology, with the use biometric offering the intention is ease the use of the technology.

D.3 Technology has evolved but the interaction with technology still lags behind, with this solution the interaction will be simplified by using the biometric data.

D.4 More so no newer simpler ways of interaction with technology are prevalent, this invention intends to remove the hurdles of access to biometric data leading to simpler ways of interaction with the technology.

D.5 E.g. checkout still takes same amount of time as before, multiple use cases can be supported by this offering which can act as an engine which can power newer use cases.

D.6 A physical credit card or device (e.g. phone) is still needed as a means of identification for payments, with this invention biometrics can be used for the form of monetary or payment service which needs no physical card or physical device.

D.7 The effective use of biometrics is the solution for credit card, or debit card or other monetary needs, as this inventions and the software, software as service as implemented does in this solution.

D.8 The system is implemented as technology agnostic. As the goal of the system is to achieve highest Interoperability, the libraries of the system is implemented in multiple programming languages. The first implementation being in C #, VC++, then java, c #with native functionality in C, C++, VC++. The interfaces written in cross platform frameworks, with mobile responsive and AR/VR convertible. Web scripting is used with HTML, javascript, ajax just to name a few, json. The system as built adheres to principles of software as a services, having containerization. The system is also resized as mobile application, tablet application, AR/VR application, web application, desktop application and server application. Further agents of biometric detections are implemented which are also encapsulated behind the API. Giving the system to simultaneously hosted on prem, data centers, and its own public cloud. All the functionality for all the modules is devel-oped with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is implemented as SAAS in multi region, communication between its different multi region SAAS, across different geographies and countries, enabling the system to work realtime.

### D.1 Detailed Description and Working of BBCDMS

D.1.1 The system as described here is the engine which makes interaction with the technology using the biometrics. This implementation encapsulates multiple existing biometrics technologies and on board them, and acts as a central engine. Using this unique approach the system is able to bring to life and power multiple, use cases which makes the infarction with the technology simpler. The system as described is next version of visa, master card etc, as the system as such does not uses any card or any de-vices for monetary transections, but uses the biometrics as such. With unique engine to onboard multiple biometrics detection and identifications systems, as they exists in external systems, and interface with multiple banking systems, payments gateways, using the generic API.

D.1.2 The external systems can use the system, service through multiple ways, that is either through using the API, or by using the agent which can be embedded in the system or platform, or using the libraries which can be embedded in the code of the platform. The agent is alight weight implementation.

D.1.3 Drawing 1: Biometrics credit, biometric debit service and biometric monetary gateway. The system as such works as full fledged bank, with debit, credit services sorely based on biometrics. Further acts also as a full fledged monetary service based on biometrics, also biometric monetary payment gateway with other banking systems. Further as depicted in section D.1

D.1.4 1 BBCDMS API, is the API layer which exposes all the sub systems and their functionality to both internal and external systems. Further as depicted in section D.1

D.1.5 2 Laser Identification Unit, is the external laser system which is used for biometric identification. No claim is being made for the laser identification system as such, in the diagram the laser system depicts the feed from the laser system which is sent for the means of identification of biometrics identification. Further as described in section D.1.

D.1.6 3 is Camera Unit, is cameras which capture the raw images for the means of biometric identification. The camera unit is the logical representation of a camera or set of cameras which send the feed to the system. Further as described in section D.1.

D.1.7 4 is External Biometric Sensor System, is the external system which captures the biometrics and sends to the system as such. Further as described in section D.1

D.1.8 5 is Biometric Security Engine, is the security engine which securely stores and transfers the biometric information. Further as described in section D.1

D. 1.9 6_is External Banking System, is the external banking system to which the system connects to for banking service based on biometrics. Here this BBCDMS system act both as a service which an external bank can use for only using the biometrics identification, or a full fledged banking system gateway which connects to another external banks. Here this BBCDMS system can act as a gateway or full fledged banking system based linking to the external bank. Further as described in section D.1.

D.1.10 7_is Biometric detection detection engine, is the internal system which takes feeds from external biometric identification systems, cameras, laser units, and detects a given biometric feed to the identity of an entity, here the entity can be a person, or a finite set of physical assets that we use in our day to day life, like a car, bike. The set of objects is finite because the set of objects that we use in our day to day life are finite, and the only aspect is to the identification of the object. Further as described in section D.1.

D.1.11 8_is External Payment System, is the external payment system to which the system connects to for payment service based on biometrics. Here this BBCDMS system act both as a service which an external bank can use for only using the biometrics identification, or a full fledged payment system gateway which uses its own payment system or connects to another payment gateways. Here this BBCDMS system can act as a gateway or full fledged banking system based linking to the external bank. Further as described in section D.1.

D.1.12 9_is Plug and play biometric adapter loading module, this module which is re-sponsible for interfacing, linking and loading a particular external biometric system. Further as described in section D.1.

D.1.13 10_is Biometric to account linker, this module links a particular identification of an entity, a person, to the particular account for that entity, a person. The system here uses both, or or, a biometric imprint hash as an account or a alphanumeric has as a account number. Further as described in section D.1.

D.1.14 11_is Credit Debit System, the system as such is core banking system which handles all the banking functions such as holding the monetary currency, keeping balances, creating bank accounts, issuing credit, debit accounts, just to name a few. As no claim is being made on the exclusiveness of this system, as the functions are typically the same that are being used by any bank for hundred of years, the only exception or exclusiveness is that the system as such only uses the biometrics as a means of identification, account verification and at times the account itself. Further as described in section D.1.

D.1.15 12_is Account Settler, is the typical banking system module which settles the transections as they occur in normal banking system. As such no claim is being made for the module as such. The only exclusive claim is the system as such uses instant account settlement rather than traditional auth, pre auth as its exists in traditional banking system.

D.1.16 13_is Currency Convertor, is the typical currency converter module that exists is normal banking systems. The system as such performs the functionality of converting one currency to another. As these modules already exists in normal banking systems, no exclusive claim is being made as such but the module is being shown for completeness.

### D.2 Detailed Description and working “Trade Secret, Generic Simplification Interface Architecture”

D.2.1 Trade secret name “generic simplification interface architecture”, which is at the core of technology interaction simplification, not only helps with the identification, detection, but also unique way of interacting with the technology using the biometric data.

### D.3 Detailed Description Working of Different Sub Systems, Systems and Interactions Between Them

D.3.1 The system is implemented as technology agnostic. As the goal of the system is to achieve highest Interoperability, the libraries of the system is implemented in multiple programming languages. The first implementation being in C #, VC++, then java, c #with native functionality in C, C++, VC++. The interfaces written in cross platform frameworks, with mobile responsive and AR/VR convertible. Web scripting is used with HTML, javascript, ajax just to name a few, json. The system as built adheres to principles of software as a services, having containerization. The system is also resized as mobile application, tablet application, AR/VR application, web application, desktop application and server application. Further agents of biometric detections are implemented which are also encapsulated behind the API. Giving the system to simultaneously hosted on prem, data centers, and its own public cloud. All the functionality for all the modules is devel-oped with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is implemented as SAAS in multi region, communication between its different multi region SAAS, across different geographies and countries, enabling the system to work realtime.

1. Claim to invent and create, biometric based credit, debit service which uses biometrics identification, the software, computer programs, APIs, software as a service, which implements the biometric based credit, debit service using biometrics identification.

2. Claim to invent and create, the monetary gateway which uses the biometric identification as a means identify an human entity.

3. Claim to invent and create, the monetary gateway can interface with any existing biometric system as such, and any existing banking system as such, using the API adhering to the specifications.
